(19) United States
(12) Patent Application Publication
(10) Pub. No.: US 2011/0265926 A1
(43) Pub. Date: Nov. 3, 2011

(54) TIRE TREAD FOR PREVENTING IRREGULAR WEAR

(75) Inventor: Gildas Yvon De Staercke, Simpsonville, SC (US)

(73) Assignees: SOCIETE DE TECHNOLOGIE MICHELIN, Clermont-Ferrand (FR); MICHELIN RECHERCHE ET TECHNIQUE S.A., Granges-Paccot (CH)

(21) Appl. No.: 13/089,716

(22) Filed: Apr. 19, 2011

Related U.S. Application Data
(60) Provisional application No. 61/328,709, filed on Apr. 28, 2010.

(51) Int. Cl. B60C 11/12

(52) U.S. Cl. 152/209.18

(57) ABSTRACT

Tires in use wear in a host of ways. One negative manner in which tires, especially truck tires, may wear is in an irregular fashion. When this phenomenon happens, the tread of the tire may become unusable, forcing the user to replace the tire, which is undesirable. This invention poses a new and useful way of preventing irregular wear, increasing the useful life of the tire tread, by placing simple sipes in the center region of the tread and complex sipes in the shoulder regions of the tread.

### PRIORITY CLAIM

This application claims the benefit of previously filed U.S. Provisional Patent Application entitled “Improved Tire Tread for Preventing Irregular Wear”, assigned U.S. Ser. No. 61/328,709, filed Apr. 28, 2010, and which is incorporated herein by reference in its entirety for all purposes.

### BACKGROUND OF THE INVENTION

1. Field of the Invention

Tires in use wear in a host of ways. One negative manner in which tires, especially truck tires, may wear is in an irregular fashion. When this phenomenon happens, the tread of the tire may become unusable, forcing the user to replace the tire, which is undesirable. This patent application poses a new and useful way of preventing irregular wear, increasing the useful life of the tire tread.

2. Description of the Related Art

Often in a sculpture design of a tire tread, the design of the shoulder area has open features (such as transversal grooves) or lamelles (also referred to as sipes). Partially because of these open features as well as the tendency of the shoulders to experience braking forces in the circumferential direction of the tire, the shoulder area is prone to develop a heel and toe wear form which can lead to more severe irregular wear, which can be extremely detrimental to the life of the tire tread. It has also been observed that continuous ribs are less prone to such wear problems. Consequently, it has been theorized that the shoulders are particularly sensitive to severe irregular wear because the load variation on the tire creates a variation in the shoulder functioning point that leads to different sliding states (positive or negative sliding) of the shoulder. If any heel & toe wear form is already established on the shoulder ribs, under negative sliding (or braking) the shoulder ribs will develop severe irregular wear. Accordingly, several methods have been used in the prior art to prevent this phenomenon from happening.

For example, U.S. Pat. No. 4,986,325 discloses the use of angled grooves and sipes that are strategically positioned and sized for improving wet traction. However, this patent also suggests that placing sipes outside the center region of the tread, which constitutes the middle 80% of the width of the tread, is disadvantageous because such placement increases the risk of heel and toe wear developing in the outer 20% of the tread found on either side of the center region of the tread, which corresponds to the shoulder regions of the tread. In particular, it recommends that sipes should not even extend partially into the shoulder regions of a tread for fear of increasing the risk of heel and toe wear (see col. 6, lines 54-59 of the '325 patent). Unfortunately, this solution to the heel and toe wear problem eliminates the use of sipes in the shoulder regions of the tread altogether, which can lead to a decrease in traction for the tire, especially when the tire is accelerating or decelerating.

Another method for preventing abnormal wear is disclosed by U.S. Pat. No. 5,316,062. It suggests using sipes having different depths in the tread of tire. Specifically, it teaches decreasing the depth of the sipes such that sipes nearer the center of the tire are deeper than sipes found nearer the shoulders of the tire (see FIGS. 2 and 3 of the '062 patent). Again, this solution has a drawback in that the traction the tire has as the tread wears will decrease since sipes near the shoulders of the tire will disappear once the tread is worn to a certain level. So this solution is not sufficient to prevent traction losses over the life of the tire tread.

Accordingly, there still exists a need to prevent heel and toe wear and the irregular wear that results from it in the shoulders of a tire in a manner that does not lead to a compromise in traction, both at the beginning and throughout the life of the tire.

### SUMMARY OF THE INVENTION

The present invention includes a tire that has circumferential, radial and axial directions and that has a tread with a center region and shoulder regions wherein said center region comprises at least one substantially two dimensional or substantially simple sipe and said shoulder regions each comprise at least one substantially three dimensional or substantially complex sipe. In some cases, the center region comprises a plurality of substantially simple sipes and no substantially complex sipe and each shoulder region comprises a plurality of substantially complex sipes and no substantially simple sipe.

In some embodiments, the substantially complex sipe has a periodic variation in the radial direction of the tire. In certain cases, the periodic variation is substantially sinusoidal about a midplane and has an amplitude, which is measured from a peak found on one side of the midplane to a peak found on the opposite side of the midplane, which is 2 mm. In still other embodiments, the sinusoidal variation has a pitch, which is defined as the distance from one peak of the variation on one side of the midplane to an adjacent peak of the variation on the same side of the midplane, which is 4 mm. In some cases, either the substantially complex or substantially simple sipe extends in a direction that is angled with respect to the radial direction of the tire.

In other embodiments, the substantially complex sipe also varies periodically in the axial direction of the tire. In some cases, the substantially complex sipe varies in a direction that is angled with respect to the axial direction of the tire.

In some embodiments, the substantially simple sipe varies periodically in the axially direction of the tire. In some cases, the substantially simple sipe varies in a direction that is angled with respect to the axial direction of the tire.

In some cases, the tire tread comprises eight ribs and the center four ribs comprise the center region of the tire and the outer four ribs comprise the shoulder regions of the tire. In certain embodiments, the width of the center region is approximately 200 mm.

In other embodiments, the substantially complex or substantially simple sipe has a gap or thickness of approximately 0.4 mm. In some embodiments, the depth of the substantially complex and substantially simple sipe is approximately 20 mm.

In some embodiments, the tire is a 445/50R22.5 sized tire. In still other embodiments, the tire tread having a substantially simple and substantially complex sipe comprises a series of ribs.

In other embodiments, the density of the sipes in the center region of the tire is greater than the density of the sipes in the shoulder regions of the tire. In such a case, the distance from one sipe in the shoulder region to another sipe in the shoulder region in the circumferential direction is approximately 40 mm and the distance from one sipe in the center region to another sipe in the center region in the circumferential direction is approximately 20 mm. In still other embodiments, the depth of the substantially complex sipe is less than the depth of the substantially simple sipe.

The present invention also encompasses a tire tread tire that has circumferential, radial and axial directions when attached to a tire, said tread having a center region and shoulder regions wherein said center region comprises at least one substantially two dimensional or substantially simple sipe and said shoulder regions each comprise at least one substantially three dimensional or substantially complex sipe. In some cases, the center region comprises a plurality of substantially simple sipes and no substantially complex sipe and each shoulder region comprises a plurality of substantially complex sipes and no substantially simple sipe.

Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 is a perspective view of a tire having a tread that uses complex or three dimensional sipes in the shoulder regions of the tire and simple or two dimensional sipes in the center region of the tire according to an aspect of the present invention.

FIG. 2 is a top view of a portion of the tread of the tire of FIG. 1.

FIG. 3 is a side cross-sectional view of the two dimensional sipes found in the center region of the tread shown in FIG. 2.

FIG. 4 is a side cross-sectional view of the three dimensional sipes found in the shoulder regions of the tread shown in FIG. 2.

FIG. 5 contains a graph that shows the rolling direction stress versus rib position for high and low loads.

### DETAILED DESCRIPTION OF THE REPRESENTATIVE EMBODIMENTS

Reference will now be made in detail to embodiments of the invention, one or more examples of which are illustrated in the Figures. Each example is provided by way of explanation of the invention, and not meant as a limitation of the invention. For example, features illustrated or described as part of one embodiment can be used with another embodiment to yield still a third embodiment. It is intended that the present invention include these and other modifications and variations. It should be noted that for the purposes of discussion, only a part of the exemplary tire embodiments may be depicted in one or more of the figures. Reference numbers are used in the Figures solely to aid the reader in identifying the various elements and are not intended to introduce any limiting distinctions among the embodiments. Common or similar numbering for one embodiment indicates a similar element in the other embodiments. One of ordinary skill in the art, using the teachings disclosed herein, will understand that the same or substantially similar features can be used on pneumatic, non-pneumatic and hybrid tires alike.

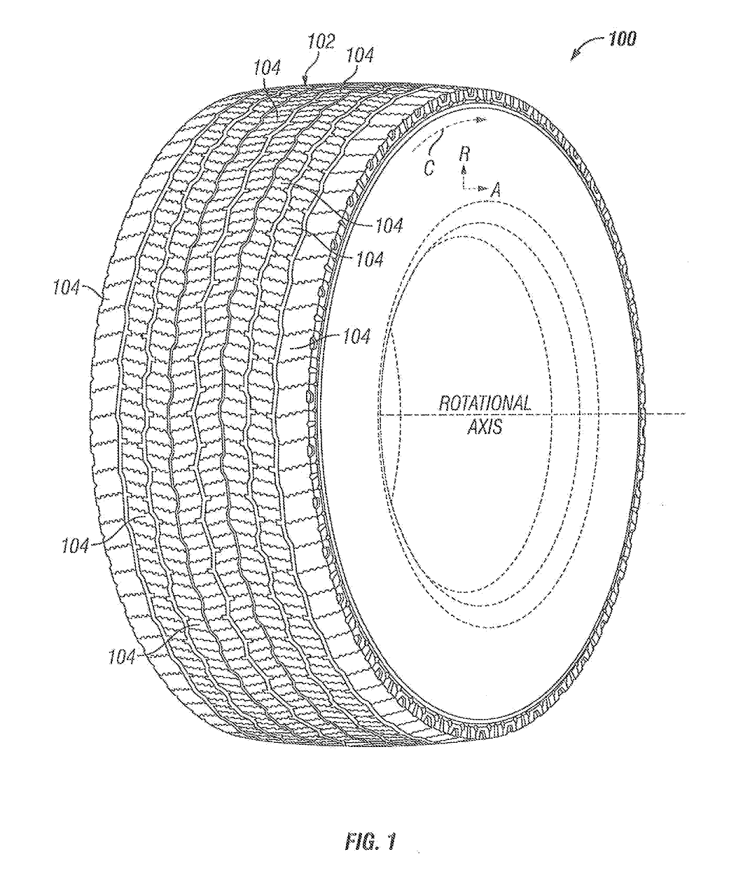

Looking at FIG. 1, a tire 100 having a tire tread 102 with attributes according to a first embodiment of the present invention is shown. The tire 100 is a 445/50R22.5 sized tire that is a double wide single tire that it is intended to replace a pair of tires used on the drive axle of large trucks. However, this invention is not limited to a particular sized tire or to a particular application and can be used on tires meant for virtually any application including applications for light trucks and cars. The tire 100 defines circumferential C, axial A and radial R directions as well as a rotational axis about which the tire 100 rotates when used. The tire 100 also has a series of eight ribs 104 that extend in the generally circumferential direction C of the tire. Although this embodiment of the present invention shows the uses of ribs, it is contemplated that the present invention could also be used on tread blocks as well.

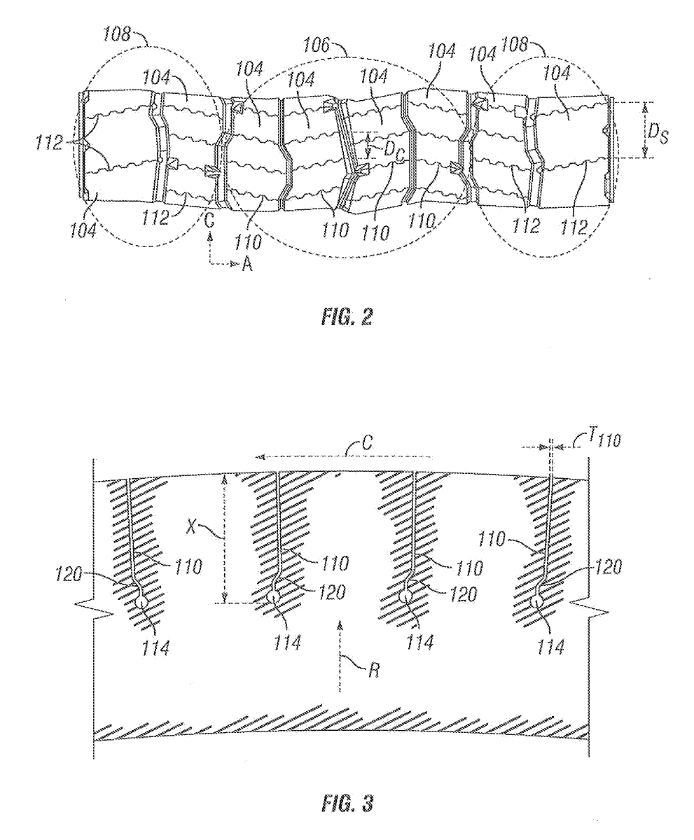

Turning to FIG. 2, a top view of a portion of the tire tread 102 of the tire 100 is more clearly depicted. There is a center region 106 that includes the four middle ribs 104 and two shoulder regions 108 that include the outer four ribs 104. The ribs 104 of the center region 106 have a plurality of sipes or lamelles 110 that are substantially two dimensional or simple sipes 110, so called because they do not have a significant amount of undercut in the draw direction of the sipes (which is the direction a mold blade travels when withdrawing from the tread to make the sipe).

On the other hand, the ribs 104 of the shoulder regions 108 have substantially three dimensional or complex sipes 112, so called because they do have a significant amount of undercut in the draw direction of the sipe. For this particular version of complex sipes, there are a series of undercuts that provide areas where one sipe wall contacts the opposite sipe wall when the tread block or rib is deformed in the circumferential direction C as the tire 100 rolls about the rotational axis, helping the block or rib resist further deformation. The profiles of both the simple and complex sipes 110, 112 in their draw direction are shown and explained in further detail later. Likewise, the manner in which the center and shoulder regions 106, 108 of the tread 102 are defined is explained more thoroughly below. It should be noted that only a portion of the center and shoulder regions are shown in FIG. 2 but that they in fact extend completely around the circumference of the tire.

Both the simple and complex sipes 110, 112 undulate in a repeating and alternating rectangular fashion and extend in a substantially axial direction A of the tire 100 along the surface of the tread 102. However, it is contemplated that they could have straight profiles where they exit the tread 102 or could undulate in some other manner such as sinusoidal or could have any arbitrary shape where they exit the tread. Furthermore, these sipes could extend in any direction forming an angle with the axial direction A of the tire 100. In addition, the density of the sipes in the shoulder region 108 is less than the density of the sipes in the center region 106 with the distance from one sipe to the adjacent sipe along the circumferential direction C on the outermost ribs, represented by dimension Dₛ, being about 40 mm. At the same time, the distance from one sipe to the adjacent sipe found on the ribs located in the center region 106 along the circumferential direction C, which represented by dimension D_{C}, is about 20 mm. It is contemplated that these dimensions could be varied as desired to achieve a suitable end result.

FIG. 3 shows the side profiles of substantially two dimensional or simple sipes 110 that are used in the center region 106 of the tire tread 102. The simple sipes 110 extend in a substantially radial direction R and have enlargements or teardrops 114 at the bottom portion for the prevention of cracking. It is contemplated that these simple sipes 110 could extend in a direction that is angled with respect to the radial direction R, provided that they could be demolded successfully. The thickness T₁₁₀ of these sipes is 0.4 mm but could be altered as desired. As can be seen, these sipes do have a small undercut 120 due to the addition of the teardrop 114 and the manner in which the sipes blades that form these sipes are manufactured. However, it is contemplated that a purely simple sipe with no undercut at all in the draw direction of the sipe would work as well. Accordingly, a substantially simple sipe that lacks an undercut over more that 50% of its depth in the draw direction of the sipe, especially near the tread surface, can be used with the present invention. Also, the depth X of these substantially simple sipes 110 is approximately 20 mm but can be varied as desired.

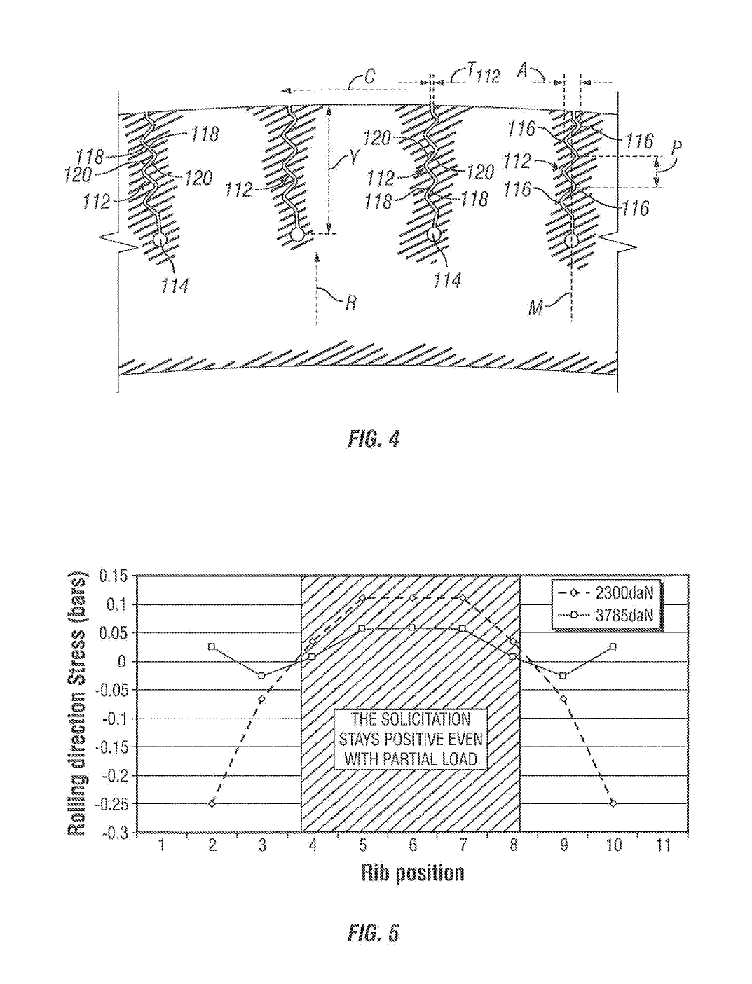

In like fashion, FIG. 4 shows the side profile of substantially three dimensional or substantially complex sipes 112 that is used in the shoulder regions 108 of the tire tread 102. The complex sipes 112 extend in a substantially radial direction R and also have enlargements or teardrops 114 at their bottom portion for the prevention of cracking. It is also contemplated that these complex sipes 112 could extend in a direction that is angled with respect to the radial direction R, provided that they could be demolded successfully.

These sipes undulate in sinusoidal fashion about a midplane M, with crests or peaks 116 being found on either side of this midplane M. Hence, these undulations define an amplitude A, which is the distance from a peak found on one side of the midplane M to a peak 116 found on the other side of the midplane M measured in a direction that is perpendicular to the midplane M. Also, these undulations define a pitch P which is the distance from one peak 116 to the next peak 116 on the same side of the midplane M measured in a direction that is parallel to the midplane M. For this particular embodiment, the amplitude A is 2 mm and the pitch P is 4 mm but these values could be altered as desired. Also, the undulations in the draw direction could have other shapes such as a repeating alternating rectangular pattern such as is shown along the tread surface. In some cases, any arbitrary shape could be used provided that it had enough of an undercut in the draw direction of the sipe to help the block or rib in which the sipe is found to resist deformation. Therefore, an fully complex sipe or substantially complex sipe that has more than 25% of its depth forming an undercut in the draw direction of the sipe, where the undercut is located near the tread surface, will work with the present invention. The thickness T₁₁₂ of the sipes is 0.4 mm and the depth Y is about 20 mm but could be altered as desired.

Looking more closely at these sipes, they form a series of undercuts 120 in the radial direction R such that the opposing sidewalls 118 will contact each other when a rib or block that contains them is deformed in the circumferential direction C as the tire 100 rolls about the rotational axis. The increase in block or rib rigidity helps to limit the formation of heel and toe wear and the abnormal wear that results from it in way that is explained more thoroughly later.

Finally, FIG. 5 is a general representation of how the center region 106 and shoulder regions 108 are typically defined to have either simple or complex sipes. The rolling direction stress is plotted versus rib position for heavy versus light loads. As can be seen, the center region is that which remains driving or positive at all times no matter how the tire is loaded. For this embodiment, this region includes the middle four ribs of the tire. To the contrary, the outside four ribs have portions that are braking or experience negative stresses. In fact, under a light load of 2300 daN, all of the outside ribs (ribs 2, 3, 9 and 10) remain braking or experience negative stresses. Since braking can cause heel and toe wear to lead to abnormal wear, it is desirable to define the outside ribs as the shoulder regions and provide them with complex sipes and in this embodiment, with fewer sipes, in order to make these ribs more rigid and less likely that heel and toe wear will develop. This in turn reduces the risk that those ribs will be prone to abnormal wear. Of course, adjustments may be made by an experienced tire designer so that the center region does not correlate perfectly with the portion of the tire, which experiences driving or positive forces at both light and heavy loads. A more detailed explanation of how the above described structure works is provided below.

From experience it is well known that the level or amount of heel and toe wear on a tire generates a global coupling, which is a force that is created in the driving direction when the tire is rotated while loaded. The quantity of heel and toe wear on the tire tread will typically keep increasing up to the point where the global coupling has reached the average usage solicitation. Once the global coupling has reached this average usage solicitation, the heel and toe wear typically stabilizes. Since the locking or substantially complex sipes in a tire tread are less sensitive to heel and toe wear than the regular or substantially simple sipes, the simple sipes located on the ribs found in the center region of the tread will generate most of the needed heel and toe wear in the center, and will minimize its formation on the shoulder and intermediate ribs, where there are risks of negative sliding and abnormal wear are the greatest. As a result, the likelihood of the tire tread developing irregular wear is minimized.

The sipes or lamelles can be full depth on all the ribs and still provide a good level of shoulder irregular wear protection. It is better to have the central ribs have lamelles that are full depth in order to facilitate the appearance of heel and toe wear in the positive stress area as shown by FIG. 5. Full depth lamelles will also provide a better lasting traction performance.

The densities of lamelles are not critical as long as the lamelle spacing in the central area is sufficient to let the heel and toe wear form to appear. However, the densities of the sipes in both the center and shoulder regions can be used to fine tune the design to achieve the desired end results. A higher density of lamelles in the shoulders could make this area more sensitive to rubber cracking and chucking so a design tradeoff may exist. Of course, it is contemplated that other properties of the tread including material compositions could be changed in order to make the shoulders more resistant to cracking as well as heel and toe wear in order to encourage the formation of heel and toe wear in the center of the tread where its progression to a more serious form of irregular wear is less likely.

It should be understood that the present invention includes various other modifications that can be made to the exemplary embodiments described herein that come within the scope of the appended claims and their equivalents. These and other embodiments of the present invention are with the spirit and scope of the claims which follow.

What is claimed is:

1. A tire that has circumferential, radial and axial directions and that has a tread with a center region and shoulder regions wherein said center region comprises at least one substantially two dimensional or substantially simple sipe and no three dimensional or complex sipe while said shoulder regions each comprise at least one substantially three dimensional or substantially complex sipe.

2. The tire of claim 1, wherein the center region comprises a plurality of substantially simple sipes and no substantially complex sipe and each shoulder region comprises a plurality of substantially complex sipes and no substantially simple sipe.

3. A tire according to claim 1, wherein the substantially complex sipe has a periodic variation in the radial direction of the tire, said periodic variation being substantially sinusoidal about a midplane and having an amplitude, which is measured from a peak found on one side of the midplane to a peak found on the opposite side of the midplane.

4. A tire according to claim 3, wherein the amplitude is 2 mm, said sinusoidal variation also having a pitch, which is defined as the distance from one peak of the variation on one side of the midplane to an adjacent peak of the variation on the same side of the midplane, which is 4 mm.

5. A tire according to claim 1, wherein either the substantially complex or substantially simple sipe extends in a direction that is angled with respect to the radial direction of the tire.

6. A tire according to claim 1, wherein the substantially complex sipe also varies periodically in the axial direction of the tire.

7. A tire according to claim 1, wherein the substantially complex sipe varies periodically in a direction that is angled with respect to the axial direction of the tire.

8. A tire according to claim 1, wherein the tire tread comprises eight ribs and the center four ribs comprise the center region of the tire and the outer four ribs comprise the shoulder regions of the tire.

9. A tire according to claim 8, wherein the width of the center region is approximately 200 mm.

10. The tire of claim 9, wherein the tire is a 445/50R22.5 sized tire.

11. A tire according to claim 1, wherein the substantially complex or substantially simple sipe has a gap or thickness of approximately 0.4 mm.

12. A tire according to claim 11, wherein the depth of the substantially complex and substantially simple sipe is approximately 20 mm.

13. A tire according to claim 2, wherein the density of the sipes in the center region of the tire is greater than the density of the sipes in the shoulder regions of the tire.

14. A tire according to claim 13, wherein the distance from one sipe in the shoulder region to another sipe in the shoulder region in the circumferential direction is approximately 40 mm and the distance from one sipe in the center region to another sipe in the center region in the circumferential direction is approximately 20 mm.

15. A tire according to claim 14, wherein the depth of the substantially complex sipe is less than the depth of the substantially simple sipe.

16. A tire tread tire that has circumferential, radial and axial directions when attached to a tire, said tread having a center region and shoulder regions wherein said center region comprises at least one substantially two dimensional or substantially simple sipe and said shoulder regions each comprise at least one substantially three dimensional or substantially complex sipe.

17. A tire tread according to claim 16, wherein the center region comprises a plurality of substantially simple sipes and no substantially complex sipe and each shoulder region comprises a plurality of substantially complex sipes and no substantially simple sipe.
